(19) United States
(12) Patent Application Publication
(10) Pub. No.: US 2013/0313895 A1
(43) Pub. Date: Nov. 28, 2013

(54) DEVICE FOR THE INDUCTIVE TRANSFER OF ELECTRIC ENERGY

(71) Applicants: Pascal Asselin, Riedisheim (FR); Andrew Green, Malsburg-Marzell (DE)

(72) Inventors: Pascal Asselin, Riedisheim (FR); Andrew Green, Malsburg-Marzell (DE)

(73) Assignee: Conductix-Wampfler GmbH, Weil am Rhein (DE)

(21) Appl. No.: 13/993,022

(22) PCT Filed: Nov. 9, 2011
(86) PCT No.: PCT/EP2011/069767

§ 371 Date: Aug. 15, 2013

(30) Foreign Application Priority Data
Dec. 14, 2010 (DE) 10 2010 054 470.1

(51) Int. Cl. H01F 38/14

(52) U.S. Cl. CPC H01F 38/14
USPC 307/9.1

(57) ABSTRACT

A device for the inductive transfer of electric energy from a stationary unit having a current supply device and a primary inductance connected thereto, to a vehicle which is adjacent to the stationary unit and has a secondary inductance. The vehicle has an emitter device for sending a data signal in the secondary inductance and the stationary unit includes a capturing device for capturing a data signal emitted by the primary inductance. The current supply device is activated by the capturing device in accordance with the content of the captured data signal for injecting the primary inductance. The emitting device includes a memory with a vehicle-specific code and the data signal which it produces contains the code. The capturing device includes a memory with an authorisation code and a comparison device such that the activation of the current supply device is triggered only if the comparison device identifies the authorisation code in the captured data signal.

The invention concerns a device for the inductive transfer of electric energy according to the preamble of claim 1.

When charging the battery of an electric vehicle, there is the need to initiate the charging process, if the vehicle has been parked at a charging station and is ready for charging. If it is necessary to establish a plug connection between the charging station and the vehicle for the charging, then this can be readily detected by the charging station and it can be used as a criterion for the start of the charging process. With an inductive connection between the charging station and the vehicle, which is established alone through the parking of the vehicle at the charging station, with a suitable alignment of a vehicle secondary coil with a stationary primary coil, the determination of the charging readiness of the vehicle proves to be more difficult. One possible solution is the setting up of a radio link between the vehicle and the charging station, for which purpose, however, both have to be specifically equipped with corresponding hardware for the communication by radio.

U.S. Pat. No. 4,347,472 discloses a device for the inductive charging of the battery of an electric vehicle in which the charging process is triggered by a switch, which is actuated by the front wheels of the vehicle when the vehicle is parked at a charging station. The charging process is ended, with a fully charged battery, by the transfer of a control signal by a charging control switch of the vehicle, via the secondary coil and the primary coil of the inductive transfer distance, to a charging control switch of the charging station. With a premature removal of the vehicle from the charging station, the charging process is again ended by the same switch by which it was originally triggered.

DE 697 14 879 T2 discloses a device for the inductive charging of the battery of an electric vehicle in which, before the beginning of a charging process, a vehicle-specific identification code is transferred from the vehicle to the charging station. The energy transfer from the charging station to the vehicle is then accepted only if a correct identification code was received. In addition to the inductive energy transfer distance, for the code transfer, an infrared transfer distance, separate therefrom, is provided.

The goal of the invention is to indicate a simple and reliable solution for initiating the charging process for the inductive charging of an electric vehicle at a charging station.

This goal is attained in accordance with the invention by a device with the features of claim 1. Advantageous developments of the invention are indicated in the subclaims.

In accordance with the invention, with a generic device for the inductive transfer of electric energy, the vehicle has an emitting device, connected to the vehicle secondary inductance and set up for the transmission of a data signal to the secondary inductance, and the stationary unit has a capturing device, connected to the primary inductance and set up to capture a data signal from the primary inductance, and the current supply device, connected to the primary inductance, can be activated by the capturing device as a function of the content of the captured data signal for the energizing of the primary inductance. In this way, the possibility is created for initiating the energy transfer from the charging station to the vehicle battery of the vehicle, using the inductive connection which had to be established, in any case, for the energy transfer. The additional hardware expense therefore remains comparatively low. In particular, no antennae and no emitting and capturing devices with respective interfaces, established separately from the energy transfer system, are needed. By the approximation of the secondary inductance to the primary inductance, which takes place for the energy transfer, the distance to be bridged with the communication for the initiation of the charging process is very small, so that a good transfer quality can also be attained with a low signal performance.

Preferably, the emitting device has a memory with a vehicle-specific code and the data signal it produces contains this vehicle-specific code. This creates the possibility for undertaking in the capturing device a comparison to an authorization code stored there. In this way, an erroneous activation of the current supply of the primary inductance by an interference signal can be reliably avoided, and before the beginning of the charging process, the authorization of the vehicle for the supply of energy at the charging station can be examined and an inadmissible drawing of energy can be prevented.

The release of a data signal with a vehicle-specific code by the emitting device can be triggered manually by the vehicle operator. However, it is also possible for it to be triggered automatically, as a function of the position of the vehicle relative to the stationary unit, detected by a vehicle sensor system, or of the speed of the vehicle—that is, when the vehicle sensor system determines that the vehicle has been parked in a position suitable for charging at a charging station, or if it moves at a very low speed indicating an imminent parking.

The invention, moreover, also creates the possibility of detecting, from the charging station, an early distance of the vehicle, in that the release of a data signal containing the vehicle-specific code by the emitting device is continued periodically after its triggering and the continued arrival of a signal containing the authorization code is monitored by the capturing device. An absence of the capturing of such a data signal, going beyond a predetermined time interval, is, in this case, a clear indication of a removal of the vehicle from the charging station, as a result of which, a deactivation of the current supply device by the capturing device can take place.

From the vehicle, the release of a data signal containing the vehicle-specific code by the emitting device can be ended either manually by the vehicle operator, or it can be ended automatically, as a function of the position of the vehicle, relative to the stationary unit, detected by the vehicle sensor system—that is, if the vehicle was removed from the charging station. For the determination of the distance, the same sensor system as for the determination of the approximation can be used. Alternative to this, the course of the inductive energy transfer can be used as a criterion, or a maximum duration can be stipulated for the release of the data signal, after whose expiration it is established.

Additional details and advantages of the invention are disclosed by the following description of an embodiment example, with the aid of the drawings. In these drawings, the figures show the following:

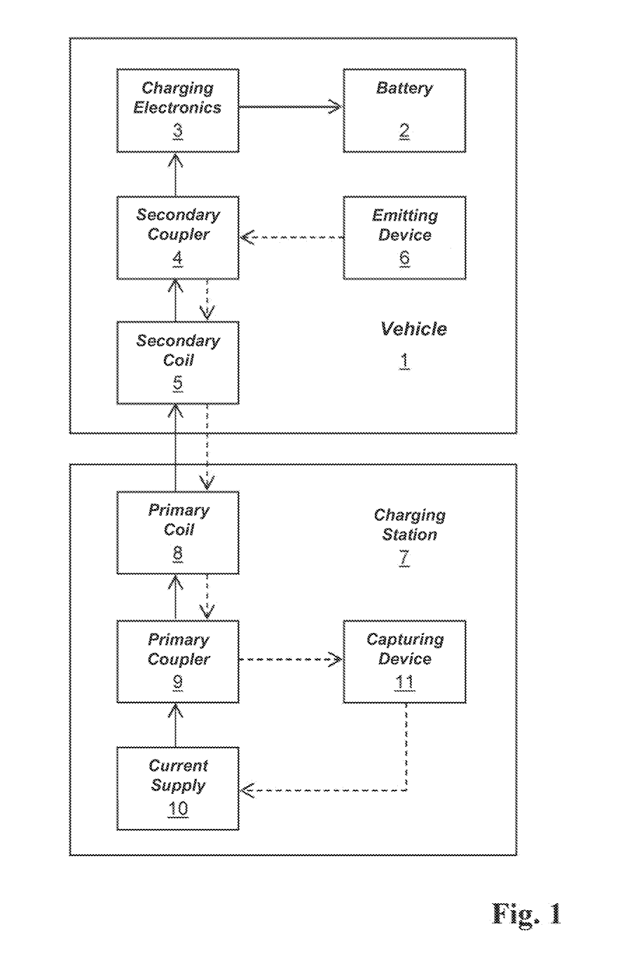

FIG. 1, a block diagram of a device in accordance with the invention;

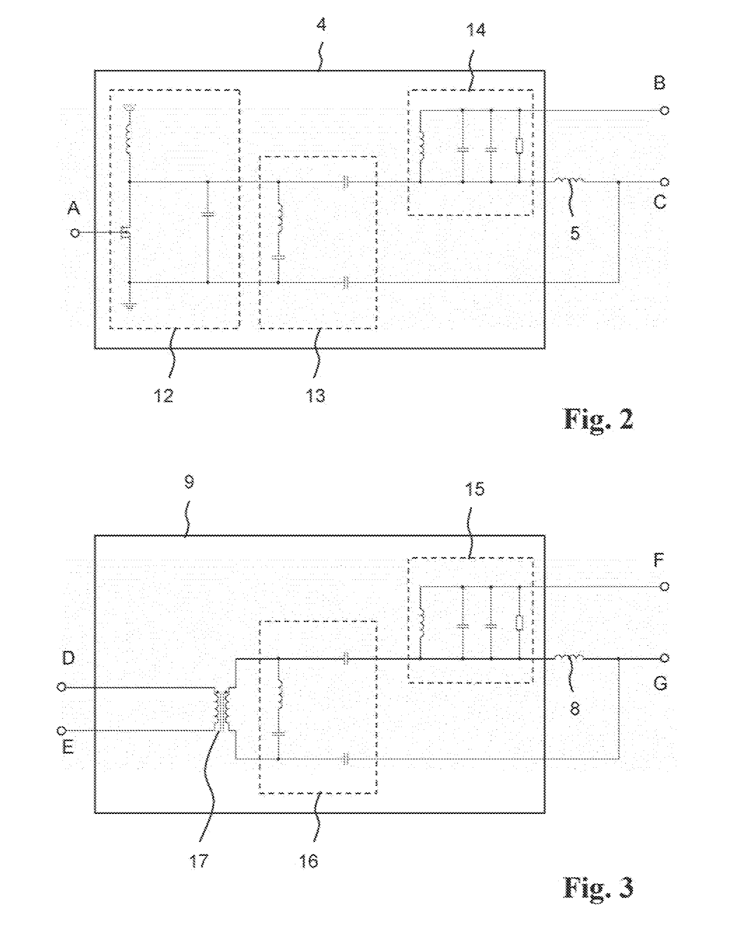

FIG. 2, a detailed circuit diagram of a part of the secondary side of a device in accordance with the invention; and

FIG. 3, a detailed circuit diagram of a part of the primary side of a device in accordance with the invention.

As the block diagram of FIG. 1 shows, an electrically driven vehicle 1, as is usual, has a battery 2, which must be regularly charged. To this end, charging electronics 3 are provided, which regulate and monitor the charging process from the vehicle. In order to be able to transfer the electric energy for the charging of the battery to the vehicle 1 in a contactless and inductive manner, the charging electronics 3 are connected, via a secondary coupler 4, to a secondary coil 5, which is preferably located on the underside of the vehicle 1. In accordance with the invention, the vehicle 1 is also equipped with an emitting device 6, which is likewise connected to the secondary coil 5 via the secondary coupler 4. The function of the emitting device 6 will be explained in detail later.

For the charging of the battery 2, the vehicle 1 is parked at a charging station 7, wherein a secondary coil 5 is placed so closely adjacent to a primary coil 8 of the charging station 7 and is aligned in a sufficiently precise manner to it that the two coils 5 and 8 together form one transformer suitable for the transfer of electric energy. The primary inductance 8 is connected, via a primary coupler 9, to a current supply device 10, from which it can be energized. This energizing, however, may only take place if a vehicle 1 with a correspondingly aligned secondary coil 5 is at the charging station 7.

In order to attain this, the charging station 7 is equipped with a capturing device 11, which works together with the vehicle emitting device 6. The capturing device 11 can trigger the energizing of the primary coil 8, and also end it, in reaction to the capture of a data signal which is sent from the emitting device 6 via the secondary coupler 4 and the secondary coil 5. Such a signal can be captured by the capturing device 11 via the primary coil 8 and the primary coupler 9. The function of the two couplers 4 and 9 results therefrom. This consists of enabling the coupling of a data signal by the emitting device 6 into the secondary coil 5 or its decoupling from the primary coil 8 to the capturing device 11, without thereby interfering with the output of electric energy from the secondary coil 5 by the charging electronics 3, or the supply of electric energy to the primary coil 8 by the current supply device 10.

FIG. 1 shows the path of the energy transfer from the current supply device 10, via the primary coupler 9, the primary coil 8, the secondary coil 5, the secondary coupler 4, and the charging electronics 3, to the battery 2 with solid arrows, whereas the path of the data transfer from the emitting device 6, via the secondary coupler 4, the secondary coil 5, the primary coil 8, and the primary coupler 9, to the capturing device 11 is shown as broken lines to mark the distinction. In this data transfer path, which runs wireless between the secondary coil 5 and the primary coil 8, the secondary coil 5 replaces an emitter antenna, and the primary coil, a capturing antenna. Also as a broken line, one can see, in FIG. 1, the control path from the capturing device 11 to the current supply device 10.

When the placement of the vehicle 1 at the charging station 7 has been concluded and the vehicle is thus ready for charging its battery 2, the emitting device 6 sends a data signal via the transfer path which was previously explained; the data signal contains a vehicle-specific code, which is deposited in a memory of the emitting device 6. This code contains information about the technical specification of the vehicle components 2-5 and regarding the authorization of the special vehicle 1 for the drawing of energy from charging stations.

The data signal is captured in the capturing device 11 and compared to an authorization code that is deposited in a memory of the capturing device 11. This authorization code contains information about the technical specifications of components 8-10 of the charging station 7 and regarding the authorization of vehicles for drawing energy from the special charging station 7. If a comparison of codes shows that the vehicle is suitable and authorized to be charged at the charging station 7, then the capturing device 11 sends a control signal to the current supply device 10, with which it is activated for the energizing of the primary coil 8. In this way, the charging of the battery 2 of the vehicle 1 at the charging station 7 begins. If the vehicle code does not correspond to the authorization code of the charging station 7, the energizing of the primary coil 8 does not take place. The user of the vehicle 1 will be given an auditory or visual warning signal, for example a red light signal.

In the simplest case, provision may be made so that the user of the vehicle 1 has to manually trigger the transmission of the data signal by the emitting device when he has correctly parked the vehicle at the charging station 7. In order to avoid forgetting the triggering, the transmission of the data signal can also be triggered automatically. For example, the charging station 7 can be equipped with characteristic markings in the form of acoustic or optical reflectors, permanent magnets, or metal strips, which can be detected by the vehicle with ultrasound sensors or optical, magnetic, or capacitive sensors, or also, a change of the inductance of the secondary coil 5 could be measured as a result of the approximation to the primary coil 8. The data signal could also always be emitted if the vehicle 1 moves at a very low speed, characteristic of the parking operation, or if it moves backwards, which normally occurs only when parking.

Via the initiation of the charging process, it is also possible, in accordance with the invention, to determine its premature ending by a removal of the vehicle 1 from the charging station 7, in that the transmission of the data signal with the vehicle-specific code by the emitting device 6, during the charging process, is periodically continued, and the capturing device 11 continuously monitors the input of a data signal containing the authorization code. If such a data signal is missing for longer than a predetermined time interval, then the capturing device 11 interprets this as a premature removal of the vehicle 1 from the charging station 7 and cancels the energizing of the primary coil 8. The removal of the vehicle 1 from the charging station 7 can, however, also be detected with the aid of another criterion, such as a measurement of the transferred power. The periodic continuation of the transmission of the data signal is not necessary in this respect, but rather only an option.

If the transmission of the data signal is continued periodically, the deactivation of the emitting device 6 can be triggered either manually by the vehicle user, or it can take place automatically, in that the removal of the vehicle 1 from the charging station 7 is detected with the same system as its correct positioning at the charging station 7 before the beginning of the charging process. Alternatively or additionally, a time-controlled switching off of the emitting device 6 after a predetermined maximum operating time can be provided.

FIG. 2 shows a detailed circuit diagram of the secondary coupler 4, which is needed for the joint use of the secondary coil 5 for energy and data transmission. As essential components, it comprises an amplifier 12, a filter 13, and a passive impedance adaptation element 14. The emitting device 6 is connected to the terminal marked with A in FIG. 2. The data signal supplied to it is raised, by an amplifier 12, to a level which is suitable for the transfer over the inductive transfer distance formed by the coils 5 and 8.

During the charging process, In order to keep the high-power signal intended for the charging electronics 3 away from the amplifier 12 and the emitting device 6 connected at A, a high-pass filter 13 is provided after the amplifier 12. The effectiveness of this measure presupposes, of course, that the frequency range of the data signal is clearly higher than that of the energy transfer, which fluctuates in the order of magnitude of 20 kHz. The secondary coil 5 is parallel to the second gate of the filter 13. One clamp is connected, via the impedance adaptation element 14, to a terminal B, and the other clamp, directly to the other terminal C of the charging electronics 3.

FIG. 3 shows a detailed circuit diagram of the primary coupler 9, which is needed for the joint utilization of the primary coil 8 for energy and data transfer. As essential components, it comprises a passive impedance adaptation element 15, a filter 16, and a transformer 17. The current supply device 10 is connected to the terminals marked with F and G in FIG. 3. The terminal G is directly connected to a clamp of the primary coil 8; the other terminal F is connected to the other terminal of the primary coil 8 via the impedance adaptation element 15.

Parallel to the primary coil 8, there is a gate for filter 16, which is likewise a high-pass filter, which keeps the high-power signal coming from the current supply device 10 away from the emitting device as a result of its frequency, which is clearly lower in a comparison with the data signal from the capturing device 11. Between the other gate of the filter 16 and the terminals D and E, to which the capturing device 11 is connected, there is a transfer device 17 for the galvanic separation and the level adaptation.

1. Device for inductive transfer of electric energy from a stationary unit with a current supply device and a primary inductance connected thereto, to a vehicle with a secondary inductance, standing adjacent to the stationary unit wherein the vehicle has an emitting device connected to the secondary inductance and set up for the supply of a data signal to the secondary inductance, and the stationary unit has a capturing device, connected to the primary inductance and set up to capture a data signal from the primary inductance, and wherein the current supply device can be activated by the capturing device, as a function of the content of the captured data signal, for the energizing of the primary inductance.

2. Device according to claim 1, wherein the emitting device has a memory with a vehicle-specific code, and the produced data signal contains the vehicle-specific code.

3. Device according to claim 1, wherein the capturing device has a memory with an authorization code and a comparison device, and the activation of the current supply device is triggered by the capturing device only if the comparison device determines the presence of the authorization code in the captured data signal.

4. Device according to claim 1, wherein the transmission of a data signal by the emitting device can be triggered either manually by the vehicle user or automatically, as a function of a position of the vehicle relative to the stationary unit as detected by a vehicle sensor system, or is triggered by the speed of the vehicle.

5. Device according to claim 3, wherein transmission of a data signal by the emitting device is periodically continued after triggering, and with absence of the capturing of a data signal containing the authorization code beyond a predetermined time interval, a deactivation of the current supply device by the capturing device takes place.

6. Device according to claim 2, wherein transmission of a data signal containing the vehicle-specific code can be ended by the emitting device either manually by the vehicle operator, or automatically, as a function of the position of the vehicle relative to the stationary unit as detected by a vehicle sensor system or by the course of the inductive energy transfer or after the duration of a predetermined maximum time has ended.
